(19) United States
(12) Patent Application Publication
(10) Pub. No.: US 2006/0004639 A1
(43) Pub. Date: Jan. 5, 2006

(54) Interstate sale control process

(76) Inventor: Edward L. O'Keefe JR., Traverse City, MI (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/157,710

(22) Filed: Jun. 21, 2005

Related U.S. Application Data
(60) Provisional application No. 60/581,918, filed on Jun. 22, 2004.

(51) Int. Cl. G06F 17/60

(52) U.S. Cl. 705/26

(57) ABSTRACT

An interstate sale control process includes seller authentication, buyer registration or authentication, transaction order identification and authorization, transaction authentication with authoritative seal, and transaction reporting. In one aspect of the invention, the seal is a shipping label with indicia of regulatory compliance. In another aspect of the invention, the sale control process is seller driven by way of a data processing unit and the data processing unit may be internet accessible. The seal may further include encrypted information, which may alternatively include electronic encryption by way of a smart chip or the like.

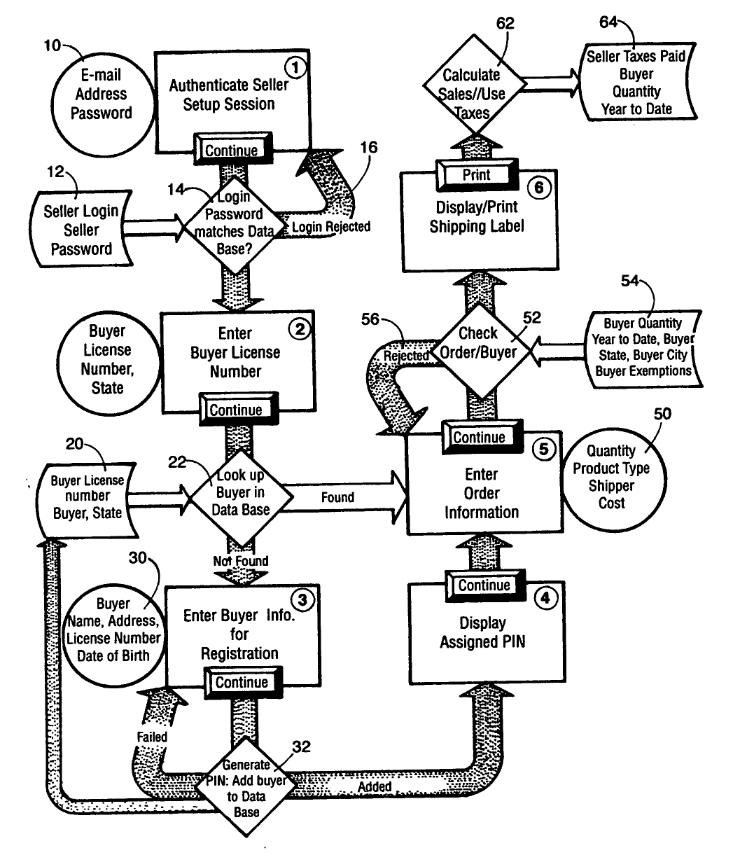

### CROSS-REFERENCE TO RELATED APPLICATIONS

This is a continuing non-provisional application of co-pending U.S. Provisional Patent Application Ser. No. 60/581,918, entitled Interstate Sale Control Process and filed on Jun. 22, 2004, by Edward L. O'Keefe, Jr., the disclosure of which is incorporated here by reference.

### BACKGROUND OF THE INVENTION

At the present time, wine is generally sold in a three step channel or distribution system, from wine makers to wholesalers to retailers to consumers. The winery or wine maker pays federal taxes on the sale to wholesalers. Wholesalers pay excise taxes on sales to retailers, and consumers pay sales taxes to retailers on the ultimate purchase of the wine. The wine maker, wholesaler, and retailer all can be the same entity so that the wine maker sometimes sells directly to consumers.

At the present time, there are substantial restrictions on interstate sales of wine, and there are restrictions on direct sales of wine from wine makers to consumers. These restrictions can vary from state to state. The law of at least one state provides that only wineries located in that state can sell directly to consumers in that state, and out-of-state wineries cannot sell direct to in-state consumers. These restrictions and other restrictions on interstate sales, particularly sales tax requirements, are often violated, especially with the availability of internet ordering.

The validity of such restrictions has also been attacked. The 21^{st} Amendment to the U.S. Constitution eliminates prohibition and gives to the states the right to regulate the sales of alcoholic beverages in the state. The Interstate Commerce Clause, however, requires that any such regulations be fair and not discriminate against interstate commerce. The practice of permitting direct sales by in-state wineries but not by out-of-state wineries was recently overturned by the U.S. Supreme Court as violating the Interstate Commerce Clause.

Legislation is being proposed for a system for permitting at least limited sales of wine directly to in-state consumers by in-state and out-of-state wineries. The present invention provides an implementation system that makes sure that all appropriate regulations are complied with and that taxes get paid and reported.

Two of the main concerns relating to wine sales are that all the appropriate taxes are paid and that only appropriate consumers (persons who are of age to drink and are not inebriated) are permitted to purchase wine directly. The preservation of the current “three step” wine distribution systems also is a concern.

Under new legislation proposed for consideration by one state, direct sales of wines from wineries to consumers is permitted, subject to licensing, registration, and quantity limitations. In one proposal, wine sellers can ship up to 24 cases of wine directly to a particular consumer per year for personal use. Consumers can purchase up to 24 cases of wine total direct from all wine sellers, for personal consumption. Sellers must be licensed and customers must be registered. Appropriate taxes must be paid to applicable taxing authorities.

In order for this system to work, there must be a method for verifying that these restrictions and requirements are enforced and to confirm that the consumer is authorized by age and any other applicable restrictions to make a particular purchase from a seller. The present invention provides such a system.

### BRIEF SUMMARY OF THE INVENTION

The present invention comprises a process and system that ensures that all taxes are paid, the consumer is qualified to make the purchase, and any quantity restrictions (or other restrictions) are complied with. While the present invention is described in connection with interstate wine sales, the invention can be applied to any type of sale involving shipment of goods by a commercial shipper, where any type of preconditions are applicable.

The present invention comprises the following elements:

1. A “Service Provider” sets up and maintains a central service, such as an on-line service, that direct sellers and others subscribe to. The service includes a database of all sales activities of the sellers and buyers and can also include tax information for all situations and tax calculation software. Sellers subscribe by filling out all the appropriate forms and charge information and tax information, so that all appropriate taxes can be paid or reported (or both) for the seller. The selling method preferably provides for the Service Provider to pay and report the taxes (and pay shipping fees as well, if desired) for the seller.

2. The Service Provider desirably provides the seller with software or online access for the purpose of preparing an invoice and shipping label for all direct sales that are to be shipped. The seller fills out an order form or invoice with all the price, tax, buyer, seller, and product order information. The buyer provides a drivers license or other identification and information confirming that the buyer is qualified to make the purchase. If desired, the buyer can be required to prequalify for direct sales by filling out an application and showing identification and getting an appropriate license or buyer's personal identification number (BPIN).

3. At the time that an order is placed proposed invoice information and sales data are prepared. In one aspect of the invention, this information is automatically electronically transmitted to the Service Provider. The Service Provider enters the sales information in the database and confirms that the seller, buyer, and quantity of purchase are acceptable. The Service Provider also desirably calculates the appropriate taxes payable to the appropriate governmental authorities. The Service Provider also can verify credit information, if desired.

4. The Service Provider then verifies the sale and informs the seller. The system can be set up so that taxes are paid automatically directly to the taxing authorities when the sale is completed; or the tax money can be transmitted to the Service Provider's account for payment by the Service Provider; or the tax information can simply be documented and reported to the taxing authorities, with the seller being responsible for payment. The software can then automatically generate a special shipping label for the shipment. All pertinent information can be printed on the label, or the information can be incorporated in a bar code or a smart chip or other scannable and preferably non-legible device on the label. When the sale is completed the sale information desirably is automatically electronically transmitted to the Service Provider for updating of the database and payment of taxes. In any case, the label indicates that appropriate arrangements for payment of taxes have been made and that the buyer is qualified

5. A commercial shipper, such as Federal Express or the like, then picks up the labeled shipment and scans the label or bar code to confirm that the sale to the buyer is approved and that the taxes have been paid. If approved, the shipment is then delivered to the customer. The customer is required to provide appropriate identification or customer or BPIN number and demonstrated sobriety before the product is delivered to the buyer. The bar code also contains information on product purchases and sales by each seller and buyer in order to verify that the sellers and buyers are within the volume limits permitted under the law. The database maintained by the Service Provider keeps constant track of the volume limits and discontinues authorization when the limits have been exceeded. The customer can be required to provide an electronic signature for delivery, and this signature can be maintained in the database. A special alphabetical order code, such as a two letter code, can be selected by this buyer or designated by the seller for each order. The code can be added to the buyer's signature on an electronic order. The buyer can then be asked to provide the order code at the time of delivery. This will prevent deliveries of any order to a person who is not authorized to receive it.

6. In addition to (or in place of) pre-verification of a sale by a seller, the sale can be verified by the shipper. When a labeled package is received by the shipper, the label is scanned and the information transmitted to the database, which in turn verifies the sale and authorizes shipment. The important feature is that authorization to ship a product is a prerequisite to shipment by a commercial shipper, and the authorization information is contained in a required shipping label. Without complying with applicable laws, a product cannot receive a shipping label that permits the product to be shipped by a commercial shipper

7. In order to operate this system, the Service Provider maintains a central database to keep track of the authorization of the buyer to make the purchase and the authorization of the sellers to sell products within the volume limitations imposed by law. The Service Provider also maintains tax records and insures that taxes are appropriately paid to the appropriate governmental entities for all product sales, so that all sellers will pay appropriate taxes to all states, even though they may not be located in the state. The Service Provider's database also can include specific information about the products ordered, such as quantities and even brands of each type or varietal of wine. This information can be tabulated and accessed for information purposes, such as for determining consumer preferences.

While the present invention is described in connection with a method for controlling interstate sale of wine under an existing three step distribution network, the present invention, wherein shipment authorization is controlled by the shipping labels provided to the shipper, can be employed for any type of out-of-state (including foreign) shipment of goods wherein some requirement needs to be complied with.

These and other features, objects, and benefits of the invention will be recognized by one having ordinary skill in the art and by those who practice the invention.

### BRIEF DESCRIPTION OF THE DRAWING

The drawing is a flow chart for a process according to the invention, whereby a service provider offers internet web access to seller, buyer, and transaction qualification data and authorization and whereby the service provider monitors taxes and tariffs.

### DETAILED DESCRIPTION

An exemplary interactive process flow chart of a preferred embodiment of a sale control process according to the invention is shown in the drawing figure. The process shown in the drawing is set in a context of a sale control service provider with an internet web page interface for convenience, although other interfacing may be used as well. More specifically, the drawing flow chart shows six basic steps, including a “Step 1” of seller authentication and setup, a “Step 2” of buyer license entry, a “Step 3” of new buyer registration, a “Step 4” of new buyer identification issue, a “Step 5” of order entry, and a “Step 6” of providing transaction-specific authorization identifying indicia.

Further, the exemplary process disclosed is “seller oriented,” which is to say that in the scenario of the three step channel of distribution for wine, a seller in each step is the active party who interacts with the sale qualification and authorization process to consummate the transaction and complete the respective distribution step. Of course, as noted above, the three steps may be foreshortened where allowed to combine the various steps into a direct sale or the like. It is also noted that a “seller oriented” perspective appears to align with dram shop liability laws, which are traditionally established at the state level and hold alcohol servers responsible for harms caused by intoxicated or underage patrons.

Thus, a seller is presumed to have a specific buyer identified and order specifics in hand. The seller begins the process by identifying himself to the system at “Step 1”. A proposed seller identification to access or login to the online service, may include an email address and a password 10, for example. Upon entry of the seller identification information into the system, the system compares 14 the entered information with a database of qualified sellers 12. If the identification information is not in the database or otherwise fails to make a match, the system loops back 16 to the “Step 1” of seller identification. Conversely, upon a successful match with database information, the process moves to the next step of identifying the buyer. The system may be configured to correct errors in identification information entry. On the other hand, the system may be strictly constructed to exclude an opportunity for circumventing the authorization process. One will note that the exemplary process that is diagramed in the flow chart drawing does not provide seller registration. Rather, the seller is qualified prior to accessing and using the system.

The buyer may be identified by a state issued license to buy, in the case of a restaurant or other business buyer or reseller, for example. Otherwise, an individual may be identified by a driver's license number, for example. With the buyer identification information entered into the system, a comparison 22 is made against buyer identification database information 20. Upon a successful match, the system jumps forward to the fifth step. Conversely, upon a failed match of buyer identification information with the database, the system offers an opportunity to register the buyer in “Step 3.”

Various buyer identifying information 30 may be required, including, without limitation, the buyer's name, address, date of birth, driver's license number, social security number, for example. The preselected buyer identification information required is, when entered into the system, compared 32 with the buyer database information 20. This time, rather than seeking a match with prior registered buyer information, the comparison is a test for clearance or blocking of the new buyer, who may be restricted for various reasons, from completing the purchase transaction. Also, inconsistent new buyer registration information may result in a failed new buyer registration. Thus, completion of a transaction with an unauthorized buyer may be stopped in “Step 3.” Alternatively, upon completion of registering a new buyer, the fourth step of assigning a new buyer personal identification number (BPIN) is entered and completed. This moves the process onto the fifth step.

Upon entering the “Step 5” of the process either directly from the second step of authorization of a prequalified buyer or through the third and fourth steps of registering a newly qualified buyer, the order specifics 50 are entered into the system. The proposed transaction or order specifics may typically include identification of product items (e.g., wine varietals and brands) and quantities. The proposed transaction is compared 52 with database information 54 for qualification of the order. The order qualification criteria may include, for example, such elements as year to date quantity purchase by the buyer, year to date quantity sales from the seller, year to date quantity of product shipped from a specific location, or year to date quantity of product shipped to a specific destination. Further by way of example, the proposed transaction may be subject to frequency limitations to spread quantities of time or subject to rationing quotas to assure accessibility.

If the specifics of the proposed transaction fail to qualify, the system moves back by loop 56 to the order information entry “Step 5.” This loop 56 may include information relative to the order rejection, possibly indicating the criteria by which the order failed. The system may or may not be configured to allow adjusting the order specifics to qualify the transaction for authorization.

Alternatively, a qualified order will proceed to “Step 6” of processing a qualified order. The qualified order processing may include preparation of a special shipping label, for example, which includes indicia of transaction authorization, which may be considered a seal of authorization from a regulating agency. A special shipping label may include indicia that is machine readable but otherwise illegible or unintelligible. That is to say that the indicia may be encrypted. The label may contain indicia of the qualification of the order, including specifics regarding the seller, the buyer, or the product qualifications. The transaction specific indicia may alternatively include recording the qualification data in an electronic device, a smart chip, that is embedded in a label for the product or in packaging for the product.

Another element of the qualified order processing is to account for taxes or other tariffs as may be appropriate 62. This accounting may include collection of the taxes or tariffs or merely reporting the taxes or tariffs due to the appropriate authority 64.

The process may include a further step of qualifying a recipient to accept an authorized shipment, which may be seen as analogous to the seller pre-registration discussed above. This further step involves cooperation by commercial carriers in the process and would require the carriers to qualify the recipient. Again as with pre-registering sellers, various criteria may be established for identifying and qualifying an authorized recipient. For example, the buyer can provide or be provided with a different two letter alphabetical code for each individual order and can be required to provide the code for receipt of the order. The code can be included along with an electronic signature on the order form and in the order receipt confirmation, both of which are stored in a database. This code minimizes the possibility of deliveries to persons who are misusing the buyer's identity.

The seller, buyer, and purchased product information collected in the Service Provider's database can be summarized and tabulated for analysis of customer profiles and preferences and other record keeping purposes.

One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, are used in the detailed description of the invention and in the claims only to convey relative positioning of various elements of the claimed invention.

What is claimed is:

1. A sale control process, comprising the steps of:
registering a buyer;
qualifying a buyer;
authenticating a seller;
authenticating a buyer;
receiving a transaction order;
qualifying a transaction;
processing a transaction;
providing transaction specific indicia;
reporting transaction data to affected agencies, and
providing a data processing device that acquires and stores seller data, buyer data, transaction data, and regulatory requirements data and that performs the buyer registration, the buyer qualification, the seller authentication, the buyer authentication, the receiving of a transaction order, the transaction order qualification, the transaction order processing, and the reporting of data to affected agencies.

2. The process of claim 1, wherein the step of providing transaction specific indicia further includes providing a shipping label that bears a seal of authorization, the seal being adapted to be read by a machine and the seal further including data that identifies at least one of the seller, the buyer, the transaction and regulatory compliance.

3. The process of claim 2, wherein the seal is encrypted.

4. The process of claim 1, wherein the step of providing transaction specific indicia further includes providing a seal of authorization in an electronic record.

5. The process of claim 4, wherein the transaction includes a shipment of goods and wherein the electronic record is included with the shipment.

6. The process of claim 5 wherein the electronic record further includes data that identifies at least one of the seller, the buyer, the transaction and regulatory compliance.

7. The process of claim 4 wherein the electronic record further includes data that identifies at least one of the seller, the buyer, the transaction, and regulatory compliance.

8. A sale control process, comprising the provision of a sale control service that registers a seller, registers a buyer, qualifies a seller, qualifies a buyer, authenticates a seller, authenticates a buyer, receives product order transaction data; qualifies a transaction order, provides transaction specific indicia, and reports transaction data to affected agencies, by way of a data processing device that incorporates seller and buyer identification data and seller and buyer qualification data.

9. The process of claim 8, wherein the step of providing transaction specific indicia further includes providing a shipping label that bears a seal of authorization, the seal being adapted to be read by a machine and the seal further including data that identifies at least one of the seller, the buyer, the transaction and regulatory compliance.

10. The process of claim 9, wherein the seal is encrypted.

11. The process of claim 8, wherein the step of providing transaction specific indicia further includes providing a seal of authorization in an electronic record.

12. The process of claim 11, wherein the transaction includes a shipment of goods and wherein the electronic record is included with the shipment.

13. The process of claim 12 wherein the electronic record further includes data that identifies at least one of the seller, the buyer, the transaction and regulatory compliance.

14. The process of claim 11 wherein the electronic record further includes data that identifies at least one of the seller, the buyer, the transaction, and regulatory compliance.

15. A sale control process data processing device that incorporates seller and buyer identification databases, seller and buyer qualification databases, and a regulatory compliance database; and that is adapted to register a buyer by receiving buyer identification information, to qualify a buyer by comparison of the buyer identification data with the regulatory compliance database, to authenticate a buyer by receiving buyer identification information and comparison of buyer identification information with the buyer identification database, to authenticate a seller by receiving seller identification information and comparison of seller identification information with seller identification database, to receive product order transaction data; to qualify a product transaction order by comparison of the product order transaction data with the regulatory compliance database, to provide transaction specific indicia, and to report transaction data to affected agencies.

16. The process of claim 15, wherein the transaction specific indicia further includes a shipping label that bears a seal of authorization, the seal being adapted to be read by a machine and the seal further including data that identifies at least one of the seller, the buyer, the transaction and regulatory compliance.

17. The process of claim 16, wherein the seal is encrypted.

18. The process of claim 15, wherein the transaction specific indicia further includes providing a seal of authorization in an electronic record.

19. The process of claim 18, wherein the electronic record is included with the shipment.

20. The process of claim 19 wherein the electronic record further includes data that identifies at least one of the seller, the buyer, the transaction and regulatory compliance.

21. The process of claim 18 wherein the electronic record further includes data that identifies at least one of the seller, the buyer, the transaction, and regulatory compliance.
